(19) United States
(12) Patent Application Publication
(10) Pub. No.: US 2012/0300120 A1
(43) Pub. Date: Nov. 29, 2012

(54) IMAGE MODULE

(75) Inventors: Wen-Po Chang, Hsinchu County (TW); Chih-Yuan Chen, Hsinchu County (TW)

(73) Assignee: ALTEK CORPORATION, Hsinchu City (TW)

(21) Appl. No.: 13/205,580

(22) Filed: Aug. 8, 2011

(30) Foreign Application Priority Data
May 26, 2011 (TW) 100118503

(51) Int. Cl. H04N 5/225

(52) U.S. Cl. 348/374; 348/E05.024

(57) ABSTRACT

An image module including a sensor, a filter, and a shading plate is provided. The filter is disposed on the sensor, and the shading plate is disposed between the sensor and the filter. The shading plate has two opposite surfaces and two adhesion layers disposed thereon separately, such that the sensor and the filter are connected to the opposite surfaces of the shading plate.

### CROSS-REFERENCE TO RELATED APPLICATION

This application claims the priority benefit of Taiwan application serial no. 100118503, filed on May 26, 2011. The entirety of the above-mentioned patent application is hereby incorporated by reference herein and made a part of specification.

### BACKGROUND OF THE INVENTION

1. Field of the Invention

The invention relates to an image module. Particularly, the invention relates to an image module having a sensor, a filter and a shielding plate.

2. Description of Related Art

With development of technology, digital cameras have gradually replaced film cameras and become commonly used life recording tools. A lens module of the digital camera generally includes a lens assembly, a filter and a sensor, etc., wherein the lens assembly is used for imaging of the digital camera, the filter is used for filtering light with a specific wavelength to prevent the sensor from receiving the light with the specific wavelength to produce noise, and the sensor is used for capturing the imaging of the lens assembly. As a volume of the lens module of the digital camera is required to be continually decreased, the large number of components therein influences reduction of the volume of the lens module, which also increases complexity for assembling the lens module.

For example, in an existing assembling process of the digital camera, in order to stably fix the filter between the lens assembly and the sensor, a fixing member (for example, a compressed sponge) is used to lean the filter against the lens assembly, and then the sensor and the lens assembly are assembled, and an adhesion layer is coated between the sensor and the fixing member to complete the assembling process.

However, according to the above assembling method, not only the volume of the lens module is hard to be reduced due to the large number of the components, but also assembling complexity and assembling cost are increased.

### SUMMARY OF THE INVENTION

The invention is directed to an image module, which has relatively less components, relatively simple assembling process and relatively low assembling cost.

The invention provides an image module including a sensor, a filter, and a shading plate. The filter is disposed on the sensor, and the shading plate is disposed between the sensor and the filter. The shading plate has two opposite surfaces and two adhesion layers disposed thereon separately, such that the sensor and the filter are respectively adhered to the two opposite surfaces of the shading plate.

In an embodiment of the invention, the sensor includes a photo sensing device and protection glass. The protection glass is packaged on the photo sensing device, and the shielding plate and the protection glass are adhered through the adhesion layer.

In an embodiment of the invention, the photo sensing device is a charge coupled device (CCD) or a complementary metal-oxide semiconductor (CMOS).

In an embodiment of the invention, the shielding plate is a ring-shape member, and the two opposite surfaces are respectively adhered to periphery of the filter and periphery of the protection glass.

In an embodiment of the invention, the image module further includes a lens assembly assembled to the sensor. The filter and the shielding plate are located between the lens assembly and the sensor.

In an embodiment of the invention, the filter is an infrared filter.

According to the above descriptions, in the invention, the shielding plate is disposed between the filter and the sensor, and the adhesion layers disposed on two opposite surfaces of the shielding plate are used to adhere the filter and the sensor on the two opposite surfaces, so that the assembling process of the image module can be implemented through relatively less components and relatively simple steps. In this way, the image module may have a simple structure, and the assembling process thereof is simple, which may reduce an assembling time and assembling difficulty.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view of an image module according to an embodiment of the invention.

FIG. 2 is an assembling schematic diagram of the image module of FIG. 1.

### DETAILED DESCRIPTION OF DISCLOSED EMBODIMENTS

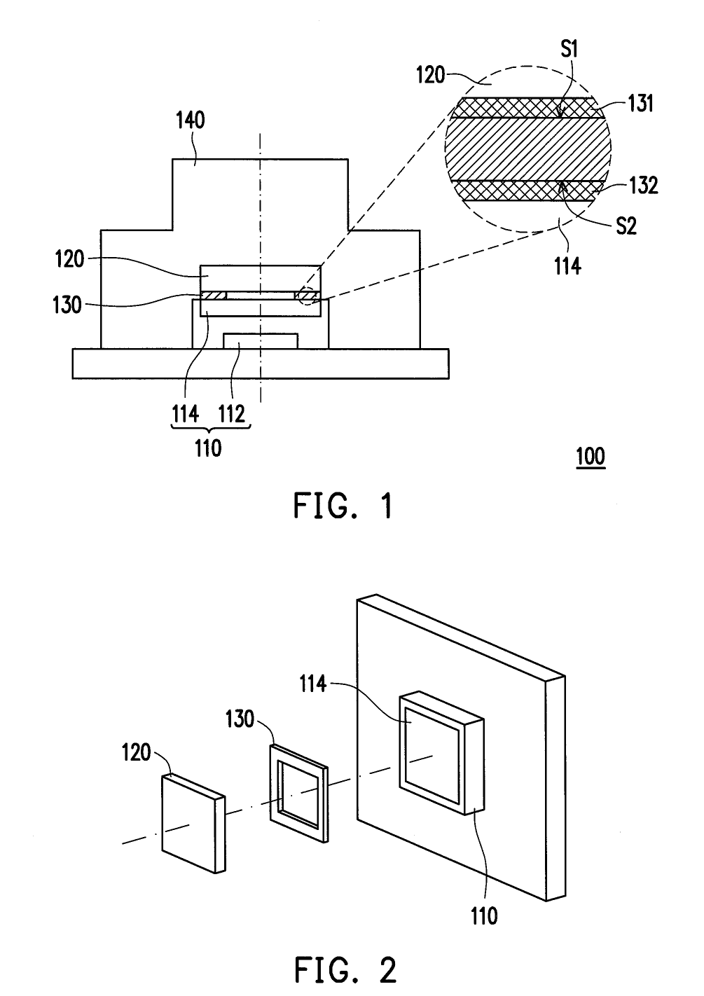

FIG. 1 is a cross-sectional view of an image module according to an embodiment of the invention. FIG. 2 is an assembling schematic diagram of the image module of FIG. 1. In FIG. 2, a lens assembly is removed to clearly present relative relationships of the other components. Referring to FIG. 1 and FIG. 2, in the present embodiment, the image module 100 is adapted to bed set in a digital camera (not shown), and includes a sensor 110, a filter 120, a shading plate 130 and a lens assembly 140, where the sensor 110 and the lens assembly 140 are assembled together, and the filter 120 and the shielding plate 130 are disposed between the lens assembly 140 and the sensor 110.

The sensor 110 is, for example, a charge coupled device (CCD) or a complementary metal-oxide semiconductor (CMOS), which is used to capture imaging of the lens assembly 140. The filter 120 is an infrared filter, which is disposed on the sensor 110 for filtering the infrared of the visible light to avoid the sensor 110 generating noises due to sensing of the infrared. The shielding plate 130 is disposed between the sensor 110 and the filter 120 to avoid an adverse effect occurred when the sensor 110 captures images due to a flare generated when the light enters the lens assembly 140.

It should be noticed that the shading plate 130 has two opposite surfaces S1 and S2 and two adhesion layers 131 and 132 disposed on the two surfaces S1 and S2, so that the sensor 110 and the filter 120 are respectively connected to the two opposite surfaces S1 and S2 of the shading plate 130. In this way, when the image module 100 is assembled, it is unnecessary to use an additional member to fix the filter 120, so that the assembling process of the image module 100 can be implemented through relatively simple components. In the present embodiment, the adhesion layers 131 and 132 are, for example, double-side adhesives adhered on the surfaces S1 and S2 of the shielding plate 130, or adhesives coated on the surfaces S1 and S2 of the shielding plate 130, which are not limited by the invention.

In the present embodiment, the sensor 110 includes a photo sensing device 112 and protection glass 114 packaged on the photo sensing device 112, and the shielding plate 130 is a ring-shape member. Accordingly, the two opposite surfaces S1 and S2 of the shielding plate 130 are substantially adhered to periphery of the protection glass 114 and periphery of the filter 120 through the adhesion layers 131 and 132. Therefore, as the shielding plate 130 is adhered to the protection glass 114 of the sensor 110, the filter 120 can be indirectly adhered to the sensor 110 through the shielding plate 130. In this way, besides the fabrication cost is reduced by simplifying fabrication members, assembling difficult is also reduced and assembling efficiency is improved.

In summary, in the invention, the shielding plate is disposed between the filter and the sensor, and the adhesion layers disposed on two opposite surfaces of the shielding plate are used to adhere the filter and the sensor on the two opposite surfaces, so that the assembling process of the image module can be implemented through relatively less components and relatively simple steps. In this way, the image module may have a simple structure, and the assembling process thereof is simple, which may reduce an assembling time and assembling difficulty.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An image module, comprising:
a sensor;
a filter, disposed on the sensor; and
a shading plate, disposed between the sensor and the filter, wherein the shading plate has two opposite surfaces and two adhesion layers disposed thereon separately, such that the sensor and the filter are respectively adhered to the two opposite surfaces of the shading plate.

2. The image module as claimed in claim 1, wherein the sensor comprises:
a photo sensing device; and
protection glass, packaged on the photo sensing device, wherein the shielding plate and the protection glass are adhered through the adhesion layer.

3. The image module as claimed in claim 2, wherein the photo sensing device is a charge coupled device (CCD) or a complementary metal-oxide semiconductor (CMOS).

4. The image module as claimed in claim 2, wherein the shielding plate is a ring-shape member, and the two opposite surfaces are respectively adhered to periphery of the filter and periphery of the protection glass.

5. The image module as claimed in claim 1, further comprising:
a lens assembly, assembled to the sensor, wherein the filter and the shielding plate are located between the lens assembly and the sensor.

6. The image module as claimed in claim 1, wherein the filter is an infrared filter.
